(19) United States
(12) Patent Application Publication
(10) Pub. No.: US 2013/0339092 A1
(43) Pub. Date: Dec. 19, 2013

(54) Marketing and Networking System and Method

(71) Applicant: Janice Brown, San Diego, CA (US)

(72) Inventor: Janice Brown, San Diego, CA (US)

(21) Appl. No.: 13/917,554

(22) Filed: Jun. 13, 2013

Related U.S. Application Data
(60) Provisional application No. 61/659,340, filed on Jun. 13, 2012.

(51) Int. Cl. G06Q 30/02

(52) U.S. Cl. CPC G06Q 30/0201
USPC 705/7.32; 705/7.29

(57) ABSTRACT

A system and method are provided which comprises a proprietary computer software that allows for relationship and contact management and promotion. The system and method may allow the user to track their activities for business development purposes. Moreover, the individual user of the system would be able to enter activity dates, along with the name of the contact. The individual user could select a contact from an address book from a database, and identify their initial activity from a list of preselected actions or enter a new activity. A point would be assigned to this activity. The system would then provide the use of the option of preselected actions along with the date to complete the action, or the user would have the ability to enter a new activity and date. The program would tally the number of points a user has accumulated on a daily, weekly, and monthly basis.

### PRIORITY CLAIM

This application claims priority to U.S. Provisional Patent Application No. 61/659,340, filed on Jun. 13, 2012.

### FIELD OF THE INVENTION

The field of the invention is for a system and method for management of business relationships. More specifically, the field of invention is for a system and method that allows for the scoring and the encouragement of marketing and networking efforts in a business climate.

### BACKGROUND

In today's internet based society, many social circles exist solely on a virtual plane. Networking websites such as Facebook.com and MySpace.com have become the norm when it relates to social networking and advertising. Typically, these sites are available to allow people to socialize, chat, share pictures and the like. These sites are not utilized for professional contacts and development. However, there are websites that are specifically targeted at professionals such as LinkedIn®.com, and some of these sites are specifically intended to allow individuals to market and network with other professionals. However, these websites are set up to be fully online interactions and many times the only type of interaction is fully virtual. Additionally, these websites are set up to give information, but do not track and do not allow configuration of their systems to allow for promotion and evolutions of networking and marketing efforts.

On the other side of the coin, there are systems in place that allow individuals, especially business professionals, to manage their clients, contacts and other resources. Many different systems have been developed and utilized by professionals such as Word®, Office® and Outlook®. These systems allow individual users to create, edit, and manage contact information, documents and presentations. The prior art also discloses document management systems, meaning systems for managing, and have reminders sent to clients, contacts and other functionality documents and contacts.

All of the above-mentioned prior art references are single purpose applications. For example, the above software are systems that are used specifically for document management and require their own network and online administrations. Additionally, these document systems cannot be utilized and configured for specific purposes or altered to fit the need of individual users. Thus, many systems offering document management systems are not available with the type of economies of scale obtainable when offered to a larger community online.

Another problem that exists is that most document management systems typically are stand alone products and usually are not connected to network systems. Further, these document management systems don't allow for editing, managing and full management of contacts, data, and documents within the system. Additionally, for those document management systems that do allow for online operation and control, most times they are remote access to a server located at a computer station and they are not completely full system operations. Therefore, these document management systems don't really help with networking, marketing and communications with contacts and business professionals.

These document management and networking functionality systems lack the user interfaces and systems to allow for effective business development and promotions. There are even contact file management systems disclosed in the prior art, such as Outlook®, that allow the management of contact files, each of which contain contact information that may be imported into document management systems and word processing applications like Word®. However, in regard to a particular person, contact file management systems like Outlook® require each of tens or hundreds or even thousands of contacts of the particular person to create, maintain and/or update a contact file corresponding to the person.

A problem that exists with document and contact file management systems is that they require contacts to be maintained, configured and managed by the individual user. Further, it does not provide a methodology of tracking and maintaining contacts for a time period. The onus is on the individual user to manage, create, delete and configure each individual contact. Further, these contact management systems typically are not integrated with any other type of management systems including creating, maintaining, and/or updating many contact files each corresponding to the single person.

Therefore a need exists for a computer software program and system that can act as a relationship manager and allow the user to track their activities for business development purposes. Additionally, a need exists for a system and method that will allow the user to track and identify business development communications with contacts and allow them to accumulate a point system to determine how much business development has been done or could be done in the future. Moreover, a need exists for a system and method for allowing the user to manage business development contacts and initiate communications with these contacts.

### SUMMARY OF THE INVENTION

The present invention describes a system and method for providing a proprietary computer software that allows for relationship manager. The system and method may allow the user to track their activities for business development purposes. Moreover, the individual user of the system would be able to enter activity dates, along with the name of the contact. The individual user could select a contact from an address book stored in a database, and identify their initial activity from a list of preselected actions or enter a new activity. A point would be assigned to this activity. The system would then provide the use of the option of preselected actions along with the date to complete the action, or the user would have the ability to enter a new activity and date. The program would tally the number of points a user has accumulated on a daily, weekly, monthly basis.

Among the many different possibilities contemplated, the system and method may be utilized by financial institutions and/or private individuals.

To this end, in a exemplary embodiment of the present invention, a system for promoting business development, the system comprising: a proprietary software to collect information relating to contact information; a database to store information pertaining to contact information; pre-selected activities for promoting business development; and a feedback export to inform users of activities and progress of business development.

In exemplary embodiment, wherein information relating to contacts is input by the individual user.

In exemplary embodiment, wherein the database includes contact information and other business information.

In exemplary embodiment, wherein the pre-selected activities comprise: calling a contact; e-mailing a contact; going to a networking function and the like.

In exemplary embodiment, wherein the pre-selected activities comprise: going to lunch with a contact; taking a contact to a function.

In exemplary embodiment, wherein the feedback export includes a progress functionality to tell the user progress of business development efforts.

In exemplary embodiment, wherein the system reviews individual progress and analyzes them to provide progress information and recommendations to improve business development efforts.

Additionally, in an exemplary embodiment, the system and method may be utilized by individuals to provide incentives to do business development.

Still another exemplary embodiment is to provide a system and method to allow individual users to utilize the system and method for business development purposes.

Another exemplary embodiment is to provide a system and method for tracking networking and business development strategies and provide options for completing specific business development tasks.

In yet another exemplary embodiment, it is contemplated that the system and method may be utilized in the form of a computer programming system.

In another exemplary embodiment, it is contemplated that the system and method may be provided whereby the system may allow tasks and activities for business development to be tracked and analyzed and a point system to be assessed.

Another exemplary embodiment is that the system and method may provide ability to enter goals for business development and may allow the user to update the system to show tasks and goals that have been completed.

In another exemplary embodiment, a system and method may be provided whereby the system may allow the users the option of selecting from pre-determined actions that must be taken for business development purposes.

Still another exemplary embodiment of the present invention is to provide a system and method for tracking, managing and creating effective business development strategies.

Yet another exemplary embodiment of the present invention is to provide a system and method for tracking, managing and developing business and creating continual contact with business associates and the like.

Another exemplary embodiment is that a system and method is provided to manage business relationships whereby the system may be updated in daily, weekly, monthly, quarterly or other timeline basis.

A further exemplary embodiment is that a system and method is provided to manage and encourage business development activities by providing the system to promote further communication with potential business contacts.

Further, a contemplated embodiment of the system and method is to provide a business management and contact system whereby the system may prompt the individual user to contact and set up activities with contacts stored within the database of the system.

Additionally, in an exemplary embodiment, a system and method is provided to promote business contacts whereby the system may have pre-determined and pre-selected activities that can be selected by the individual user and may provide goals for the user to achieve which indirectly encourages the individual user to perform more business development.

Still another exemplary embodiment of the present invention is to provide a system and method for promoting business relationships whereby the system provides feedback regarding business development efforts.

These and other aspects of the present invention will become apparent to those skilled in the art after a reading of the following description of the preferred embodiments in combination with the figures.

### BRIEF DESCRIPTION OF THE DRAWING

FIG. 1 illustrates a block diagram of an exemplary embodiment of a business relationship management system in accordance with the systems and methods of the present invention.

FIG. 2 illustrates an exemplary embodiment of a user interface in accordance with the systems and methods described herein.

FIG. 3 illustrates an exemplary embodiment of a calendar interface in accordance with the systems and methods described herein.

FIG. 4 illustrates an exemplary embodiment of a contact selection interface in accordance with the systems and methods described herein.

FIG. 5 illustrates an exemplary embodiment of a contact data interface in accordance with the systems and methods described herein.

FIG. 6 illustrates an exemplary embodiment of an activity selection interface in accordance with the systems and methods of the present invention.

FIG. 7 illustrates an exemplary embodiment of a custom activity interface in accordance with the systems and methods of the present invention.

FIG. 8 illustrates an exemplary embodiment of a follow-up activity interface in accordance with the systems and methods described herein.

FIG. 9 illustrates an exemplary embodiment of a follow-up activity date selection interface in accordance with the systems and methods described herein.

FIG. 10 illustrates an exemplary embodiment of a progress analysis interface in accordance with the systems and methods described herein.

### DETAILED DESCRIPTION OF THE PREFERRED EMBODIMENT

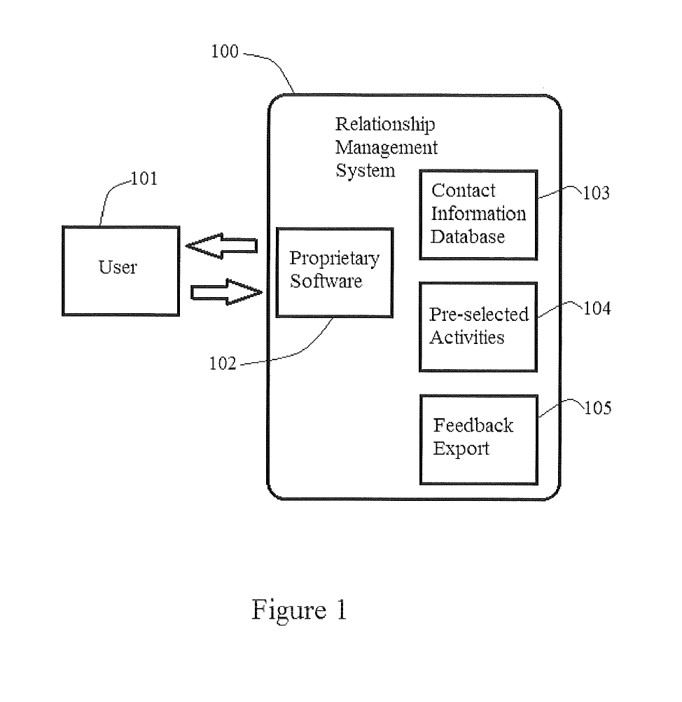

FIG. 1 illustrates a block diagram of an exemplary embodiment of a business relationship management system 100 in accordance with the systems and methods of the present invention. In the illustrated embodiment, a user 101 interacts with the business relationship management system 100 via a proprietary software 102. The proprietary software 102 enables the user 101 to store and later retrieve contact information from within a storage database 103. The proprietary software 102 may be comprised of a series of screens or dialog boxes that enable the user 101 to input and view selections. A group of pre-selected activities 104 enables the user 101 to associate one or more predefined activities with each contact stored in the storage database 103. The predefined activities envisioned may include, but are not limited to calling a contact, emailing a contact, and going to a networking function. The networking function may include, but is not limited to taking a contact to lunch, and taking a contact to a business development function. Additionally, it is envisioned that the user 101 may create custom activities that are added to the group of pre-selected activities 104 and made available for association with the contacts in the storage database 103. Furthermore, the proprietary software 102 enables the user 101 to associate each activity with a specific date on which the activity is scheduled to occur.

The business relationship management system 100 also includes a feedback export 105, which provides the user 101 with information about the progress of business efforts. It is envisioned that said information may comprise a point scoring system, or other similar grading device. One or more points may be assigned to each of the pre-selected activities 104. Once the user 101 completes an activity on the scheduled date, the feedback export 105 tallies the number of points accumulated and then proprietary software 102 displays the number of points to the user 101. The proprietary software 102 may also display recommendations to assist the user 101 with future business strategy and development efforts.

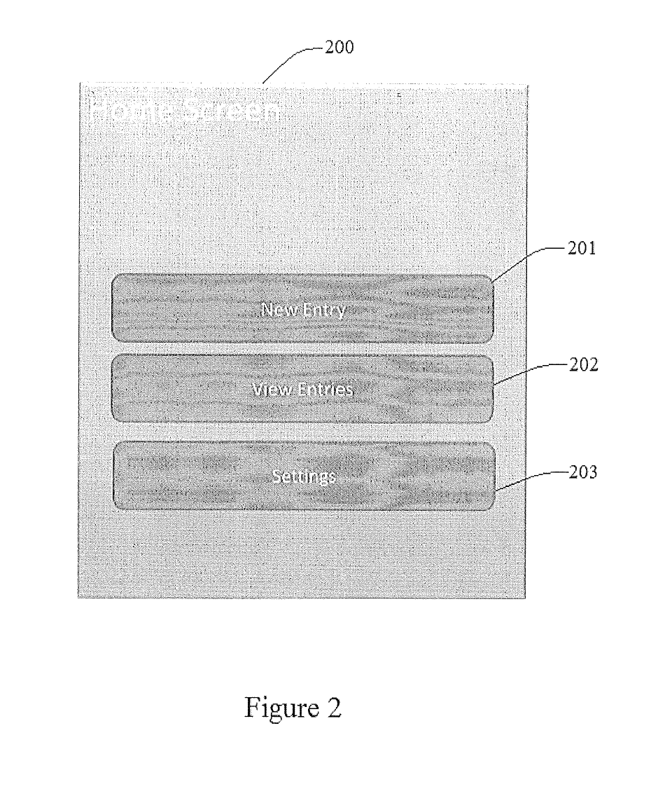

FIG. 2 illustrates an exemplary embodiment of a user interface 200 in accordance with the systems and methods described herein. The user interface 200 provides the user 101 with access to information and selections within the business relationship management system 100. In the embodiment shown, user interface 200 is a screen which is displayed on a computer monitor. In other embodiments, the user interface 200 may be a dialog box, or other similar input device. User interface 200 includes buttons 201, 202 and 203 that provide the user 101 with access to specific areas and functions within the proprietary software 102. Each of the buttons 201, 202 and 203 includes a textual label which identifies a specific area that is accessible within the proprietary software 102. Alternatively, in other embodiments, the buttons 201, 202 and 203 may comprise click boxes or, more generally, clickable areas within the user interface 200. In other embodiments, the user interface 200 may include other buttons and input devices than those shown in FIG. 2. For example, the buttons 201, 202 and 203 may each include an identifying image in addition to, or in place of the textual label.

A central function of the user interface 200 is to provide the user 101 with access to contact information stored in the storage database 103, and to enable the user 101 to add new contact information to the storage database 103. In the illustrated embodiment, activating button 201, such as by clicking with a computer mouse or other similar input device, prompts the proprietary software 102 to allow the user 101 to enter new contact information. Clicking on button 202 prompts the proprietary software 102 to display contact information already existing in storage database 103. Clicking on button 203 prompts the proprietary software 102 to allow the user 101 access to settings and information that affects the performance of the proprietary software 102. These functions and settings are described in more detail in the following paragraphs.

Although there is a wide variety of settings that may be incorporated into the proprietary software 102, a critical setting is the current date, upon which all other scheduled dates are based. Each of the pre-selected activities 104 is associated with a specific date on which the activity is scheduled to be performed. All scheduled dates are based on the current date, which must be specified by the user 101.

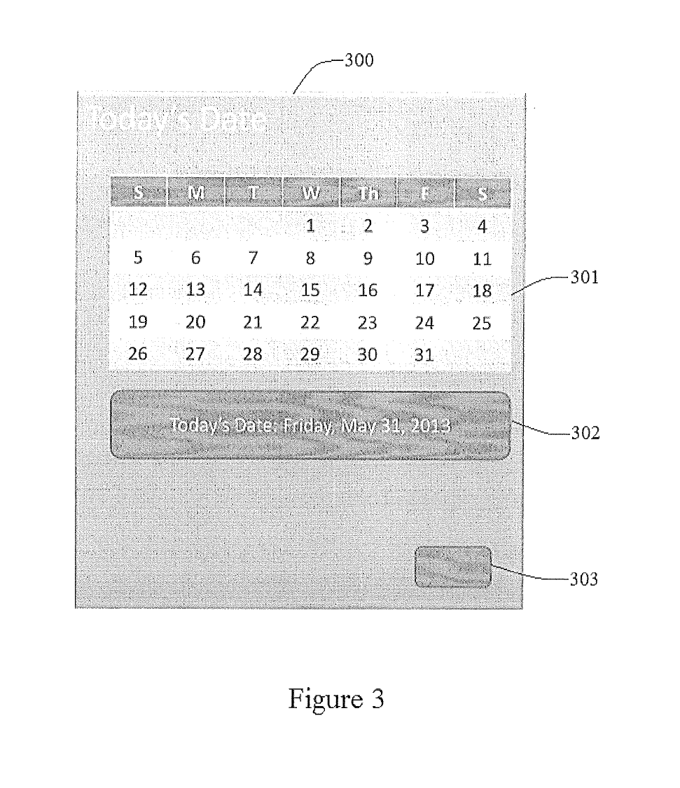

FIG. 3 illustrates an exemplary embodiment of a calendar interface 300 in accordance with the systems and methods described herein. Activating the button 203 prompts the proprietary software 102 to display the calendar interface 300. In the illustrated embodiment, the calendar interface 300 comprises a screen or dialog box which includes, but is not necessarily limited to, a interactive calendar panel 301, a date box 302, and button 303. The interactive calendar panel 301 enables the user 101 to specify the current date by selecting the present year, month and day. The date box 302 displays the date associated with the selections made by the user 101 in the interactive calendar panel 301. Activating the button 303 prompts the proprietary software 102 to save the selected date shown in the date box 302 and close the calendar interface 300, returning the user 101 to the user interface 200.

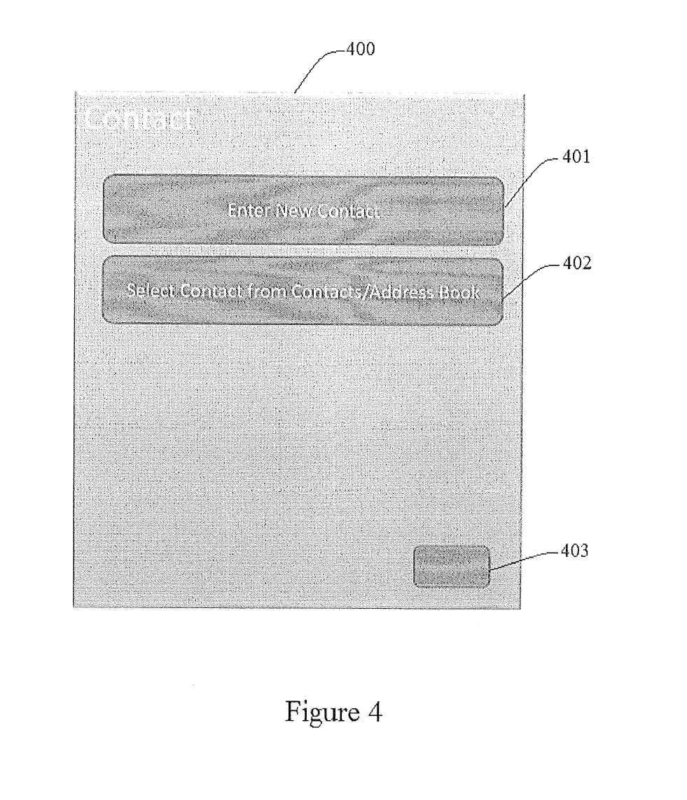

Activating button 201 prompts the proprietary software 102 to close the user interface 200 and display a contact selection interface. FIG. 4 illustrates an exemplary embodiment of a contact selection interface 400 in accordance with the systems and methods described herein. The contact selection interface 400 comprises controls 401 and 402, and a button 403. In the illustrated embodiment, the controls 401 and 402 are buttons, but may be comprised of any other similar device for inputting selections into the proprietary software 102. Activating control 401 indicates to the proprietary software 102 that the user 101 intends to enter new contact information. Alternatively, activating control 402 indicates that the user 101 intends to select an existing contact from among the contacts in the storage database 103. Activating button 403 prompts the proprietary software 102 to close the contact selection interface 400, save any selections input by the user 101, and display the user interface 200.

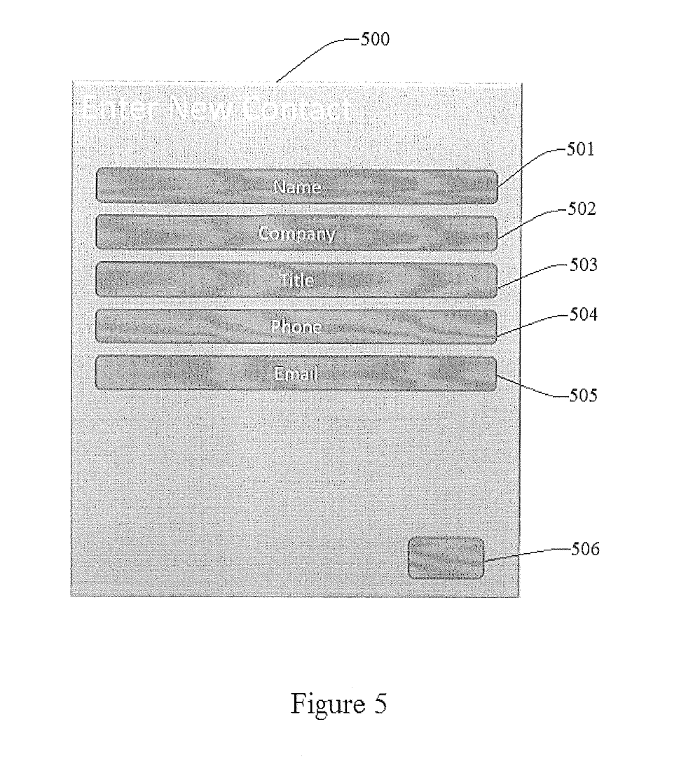

When the user 101 activates control 401, the proprietary software 102 displays a contact data interface. FIG. 5 illustrates an exemplary embodiment of a contact data interface 500 in accordance with the systems and methods described herein. In the embodiment illustrated in FIG. 5, the contact data interface 500 comprises a screen or dialog box which includes, but is not necessarily limited to, controls 501, 502, 503, 504, 505 and a button 506. Each of the controls 501, 502, 503, 504, 505 enables the user 101 to enter specific contact data. As shown in FIG. 5, the control 501 enables the user 101 to enter the contact's name. The control 502 enables the user 101 to enter the contact's company or employer. The control 503 enables the user 101 to enter a title or position for the new contact. Similarly, the contact's phone number and email address may be respectively entered by activating controls 504 and 505. It is envisioned that the contact data interface 500 may comprise other similar controls, facilitating the entry of a wide variety of other data, and is not necessarily limited to the controls illustrated by FIG. 5. Activating button 506 prompts the proprietary software 102 to close the contact data interface 500 and display an activity selection interface.

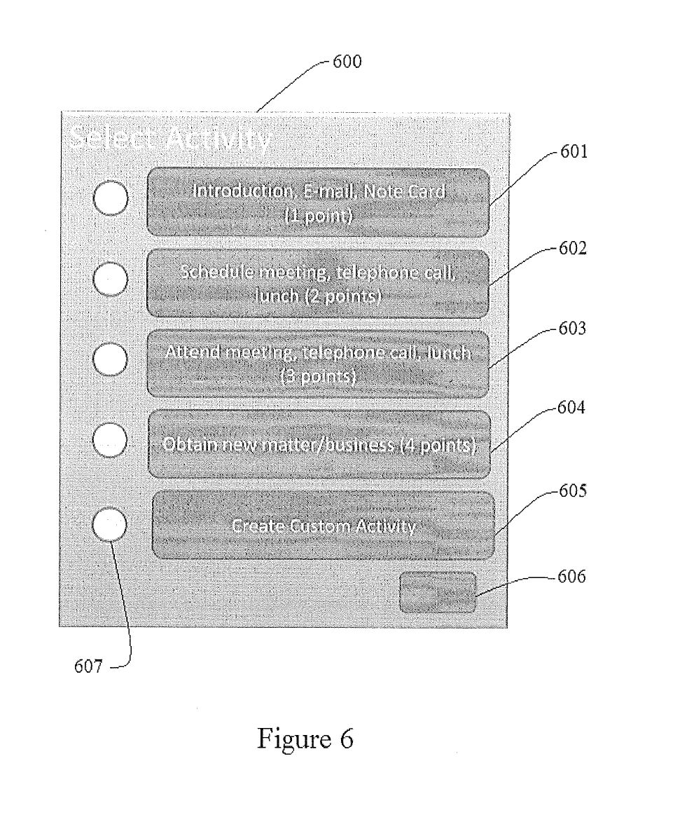

FIG. 6 illustrates an exemplary embodiment of an activity selection interface 600 in accordance with the systems and methods of the present invention. In the illustrated embodiment, the activity selection interface 600 comprises a screen or dialog box which includes, but is not necessarily limited to, controls 601, 602, 603, 604, 605, a button 606, and a series of indicators 607. It is envisioned that in one or more embodiments, selections may be made either by activating the indicators 607 or the controls 601, 602, 603, 604 and 605. As shown in FIG. 6, each of the controls 601, 602, 603, and 604 is associated with specific activities that are assigned a point value. The controls 601, 602, 603, and 604 enable the user to assign predefined activities to the contact selected in the contact data interface 500. Once the user 101 later completes the activity assigned to the contact, the number of points associated with the activity will be awarded to the user 101 and utilized to evaluate user's progress of business development.

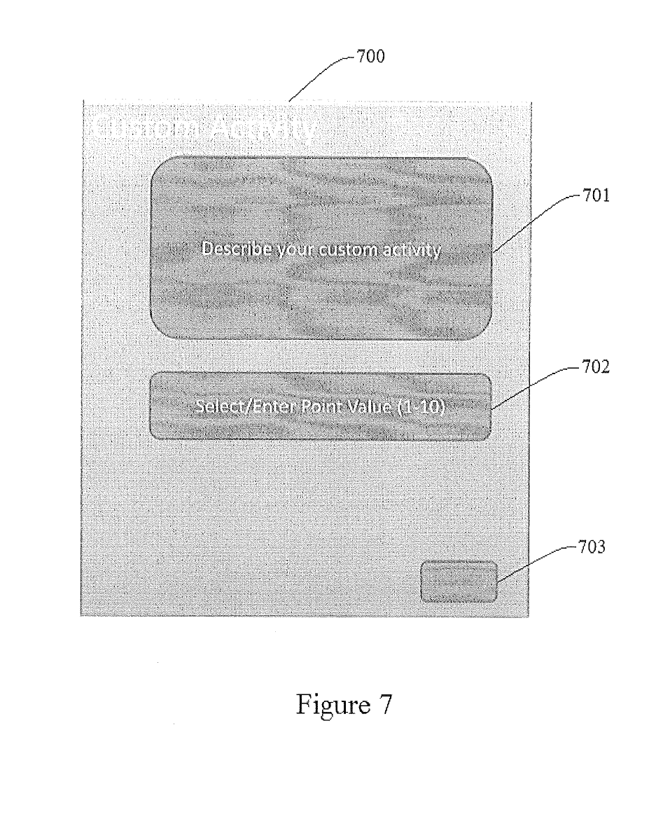

In the exemplary embodiment of FIG. 6, control 605 enables the user 101 to enter a custom activity to be assigned to the contact selected in the contact data interface 500. Activating control 605 prompts the proprietary software 102 to display a custom activity interface 700. FIG. 7 illustrates an exemplary embodiment of the custom activity interface 700 in accordance with the systems and methods of the present invention. The custom activity interface 700 comprises controls 701 and 702, and a button 703. Control 701 enables the user 101 to describe a custom activity to assign to the contact selected in the contact data interface 500. Control 702 enables the user 101 to associate a specific point value with the custom activity described in control 701. Activating button 703 prompts the proprietary software 102 to save the information entered into controls 701 and 702, and then return the user 101 to the activity selection interface 600. With reference again to FIG. 6, activating the button 606 prompts the proprietary software 102 to close the activity selection interface 600 and then display a follow-up activity interface 800.

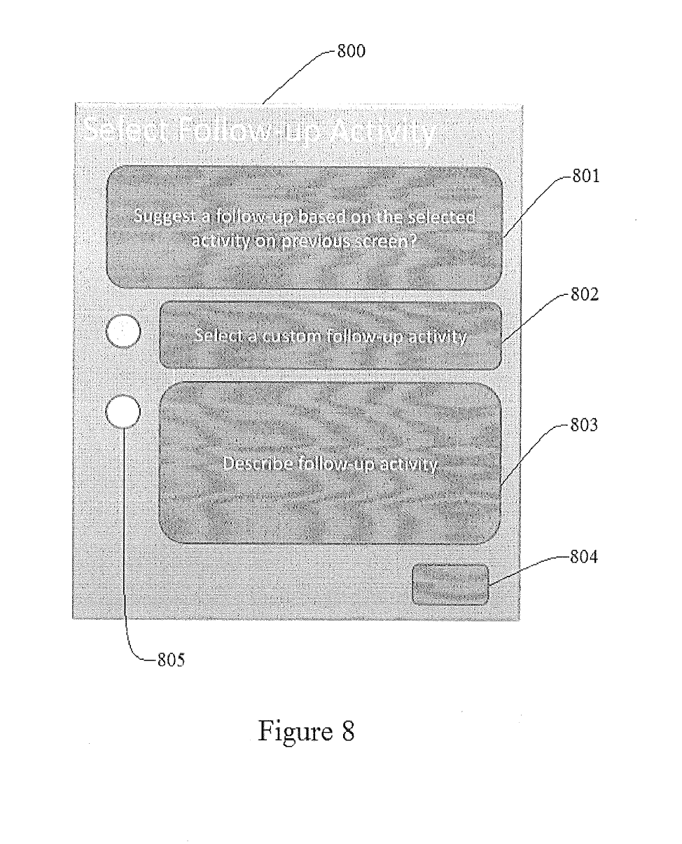

FIG. 8 illustrates an exemplary embodiment of a follow-up activity interface 800 in accordance with the systems and methods described herein. In the illustrated embodiment, the follow-up activity interface comprises controls 801, 802, and 803, a button 804, and indicators 805. It is envisioned that in one or more other embodiments, selections may be made either by activating the indicators 805 or the controls 801, 802, and 803. Activating control 801 prompts the proprietary software 102 to close the follow-up activity interface 800 and display the activity selection interface 600 shown in FIG. 6. Control 802 enables the user 101 to select a custom activity previously entered into the custom activity interface 700. Alternatively, activating control 803 enables the user 101 to describe a new custom activity to assign as a follow-up activity for the contact that is selected in the contact data interface 500. Activating button 804 prompts the proprietary software 102 to close the follow-up activity interface 800 and display a follow-up activity date selection interface 900.

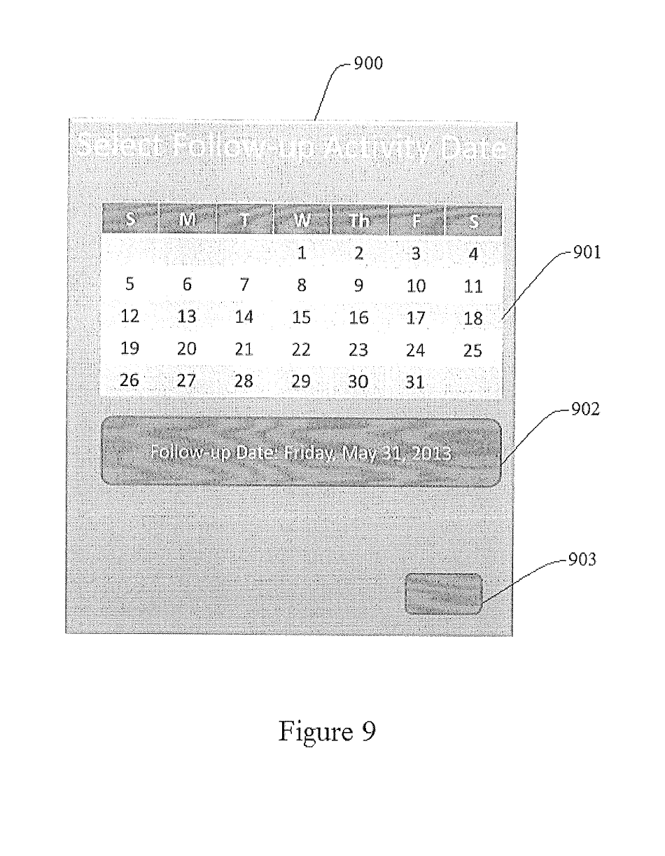

FIG. 9 illustrates an exemplary embodiment of a follow-up activity date selection interface 900 in accordance with the systems and methods described herein. In the illustrated embodiment, the follow-up activity date selection interface 900 comprises a screen or dialog box which includes, but is not necessarily limited to, a interactive follow-up calendar panel 901, a follow-up date box 902, and button 903. The interactive follow-up calendar panel 301 enables the user 101 to specify a follow-up date by selecting the year, month and day of the follow-up activity. The follow-up date box 902 displays the date associated with the selections made by the user 101 in the interactive follow-up calendar panel 901. Activating the button 903 prompts the proprietary software 102 to save the selected date shown in the follow-up date box 902 and close the follow-up activity date selection interface 900, returning the user 101 to the user interface 200.

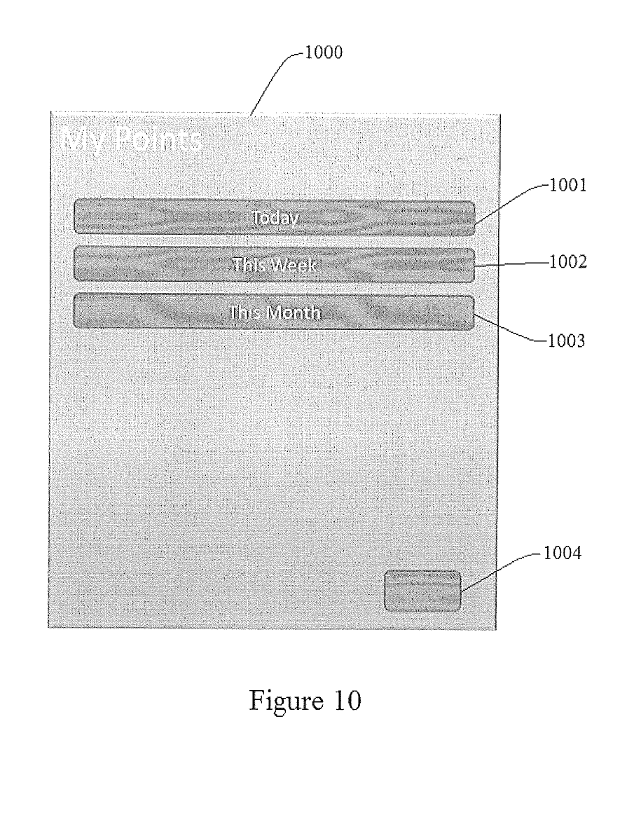

FIG. 10 illustrates an exemplary embodiment of a progress analysis interface 1000 in accordance with the systems and methods described herein. The progress analysis interface 1000 enables the user 101 to view the number of points accumulated. In the illustrated embodiment, the progress analysis interface 1000 comprises controls 1001, 1002, and 1003, and a button 1004. Activating control 1001 enables the user 101 to view the number of points accumulated during the current day. The number of the point accumulated during the current week are displayed when control 1002 is activated. Similarly, activating control 1003 enables the user 101 to view the number of points accumulated during the current month. It is envisioned that the proprietary software 102 may also display recommendations to assist the user 101 with future business strategy and development efforts.

What is claimed is:

1. A system for promoting business development, the system comprising:
a proprietary software to collect information relating to contact information;
a database to store information pertaining to contact information;
pre-selected activities for promoting business development; and
a feedback export to inform users of activities and progress of business development.

2. The system as recited in claim 1, wherein information relating to contacts is input by the individual user.

3. The system as recited in claim 1, wherein the database includes contact information and other business information.

4. The system as recited in claim 1, wherein the pre-selected activities comprise: calling a contact; e-mailing a contact; going to a networking function and the like.

5. The system as recited in claim 1, wherein the pre-selected activities comprise: going to lunch with a contact; taking a contact to a function.

6. The system as recited in claim 1, wherein the feedback export includes a progress functionality to tell the user progress of business development efforts.

7. The system as recited in claim 1, wherein the system reviews individual progress and analyzes them to provide progress information and recommendations to improve business development efforts.
